(19) United States
(12) Patent Application Publication
(10) Pub. No.: US 2017/0206933 A1
(43) Pub. Date: Jul. 20, 2017

(54) SYSTEMS AND METHODS FOR INDEXING MEDIA STREAMS FOR NAVIGATION AND TRICK PLAY CONTROL

(71) Applicant: ARRIS Enterprises, Inc., Suwanee, GA (US)

(72) Inventor: Jack E. Surline, Langhorne, PA (US)

(21) Appl. No.: 15/000,617

(22) Filed: Jan. 19, 2016

(51) Int. Cl. G11B 27/34; G11B 27/10; H04N 21/472; H04N 21/845; G11B 27/30; H04N 21/4147

(52) U.S. Cl. CPC G11B 27/34; G11B 27/3081; H04N 21/4147; H04N 21/47217; H04N 21/8455; G11B 27/102

(57) ABSTRACT

Systems and methods are provided that allow for media stream indexing and frame tagging for trick mode playback and navigation of digital video. A method of indexing a media stream is disclosed. The method includes: receiving a media stream having a plurality of frames including a current target frame, a previous target frame and a next target frame; inserting an empty navigation control block (NCB) proximate to the current target frame to which it is associated; and populating the NCB with data including offset data for the previous target frame, current target frame and next target frame.

### FIELD

The disclosure relates generally to the field of systems, devices and methods for dynamically navigating and controlling trick mode playback. More specifically to media stream indexing and frame tagging to facilitate trick mode playback and navigation of digital video.

### BACKGROUND

Digital video recorders (DVRs) (also known as personal video recorders (PVRs)) provide flexible features for recording and playing back audiovisual programming (e.g., television programs). DVR users are able to record programming content to hard disc drives (HDDs) and later play back the recorded content as desired. Because the content being played back is accessed from a local data store, DVR users are able to fast-forward, rewind, pause, and skip programming content. Further, DVR users are able to view content in slow motion, or even rapidly jump forward or backward though the content to desired points in programs. Such DVR playback features are commonly referred to as trick play modes and allow DVR users to play back recorded programs at selected speeds in forward or reverse directions.

The programming content recorded and played back by DVRs is typically in the form of Motion Pictures Expert Group Two (MPEG-2) streams (e.g., program or transport streams), which carry video content in sequentially ordered picture frames commonly referred to as elementary video streams. The picture frames include several different types of picture frames, such as I, B, and P frames. In MPEG-2 video streams, B and P type frames are positioned between I-frames to form groups of frames known as Groups of Pictures (GOPs). A GOP typically includes an I-frame and sequentially subsequent B and P frames up to the next I-frame in the video stream. The number of frames in a GOP defines the size, or length, of the GOP.

In the past, the size of the GOP has been used to navigate video streams and realize trick mode playback. Alternatively, a separate table/file of index data could be used navigate video streams and realize trick mode playback. However, both of these methods have limitations. Consequently, new methods for indexing a video stream are desirable.

### SUMMARY

Accordingly, there are provided herein systems and methods that allow for media stream indexing and frame tagging to facilitate trick mode playback and navigation of digital video.

In a first aspect, a method of indexing a media stream is disclosed. The method includes: receiving a media stream having a plurality of frames including a current target frame, a previous target frame and a next target frame; inserting an empty navigation control block (NCB) proximate to the current target frame to which it is associated; and populating the NCB with data including offset data for the previous target frame, current target frame and next target frame.

In a second aspect, a system for navigating a media stream having a previous target frame, a current target frame, and a next target frame is disclosed. The system includes: a data store for storing a media stream and navigation data for navigating said media stream, said navigation data provided in one or more navigation control blocks (NCBs) inserted proximate to a target frame in the media stream; and a processor module in communication with said data store and configured to access said media stream, said processor module including a decoder configured to decode said current target frame in the media stream and extract the navigation data from the NCB.

### BRIEF DESCRIPTION OF THE DRAWINGS

The details of the present disclosure, both as to its structure and operation, may be understood in part by study of the accompanying drawings, in which like reference numerals refer to like parts. The drawings are not necessarily to scale, emphasis instead being placed upon illustrating the principles of the disclosure.

FIG. 1A is a block diagram illustrating a digital video recording (DVR) system implemented in a set-top box configuration, in accordance with an embodiment.

FIG. 1B is a block diagram illustrating a digital media player (DMP) in accordance with an embodiment.

FIG. 2 is a block diagram illustrating frames of a segment of a directly recorded MPEG-2 elementary video stream and associated navigation data generated by the DVR system of FIG. 1A, in accordance with an embodiment.

FIG. 3 is a block diagram illustrating an example navigation control block (NCB) generation system in accordance with an embodiment.

FIG. 4 is a block diagram illustrating example frame progression in accordance with an embodiment.

FIG. 5 is a block diagram illustrating example navigation control block bidirectional navigation in accordance with an embodiment.

FIG. 6 is a block diagram illustrating a playback path of a DVR system with video decoder management of NCB data in accordance with an embodiment.

FIG. 7 is a block diagram illustrating a playback path of a DVR system with host processor management of NCB data in accordance with an embodiment.

FIG. 8 is a flowchart illustrating a method for creating navigation control blocks in accordance with an embodiment.

### DETAILED DESCRIPTION

The present disclosure describes methods and systems for dynamically indexing a media stream. Such methods create in-stream navigation control blocks (NCBs) for targeted frame types and allows for bi-directional media navigation to enable controlling video trick play modes and stream positioning.

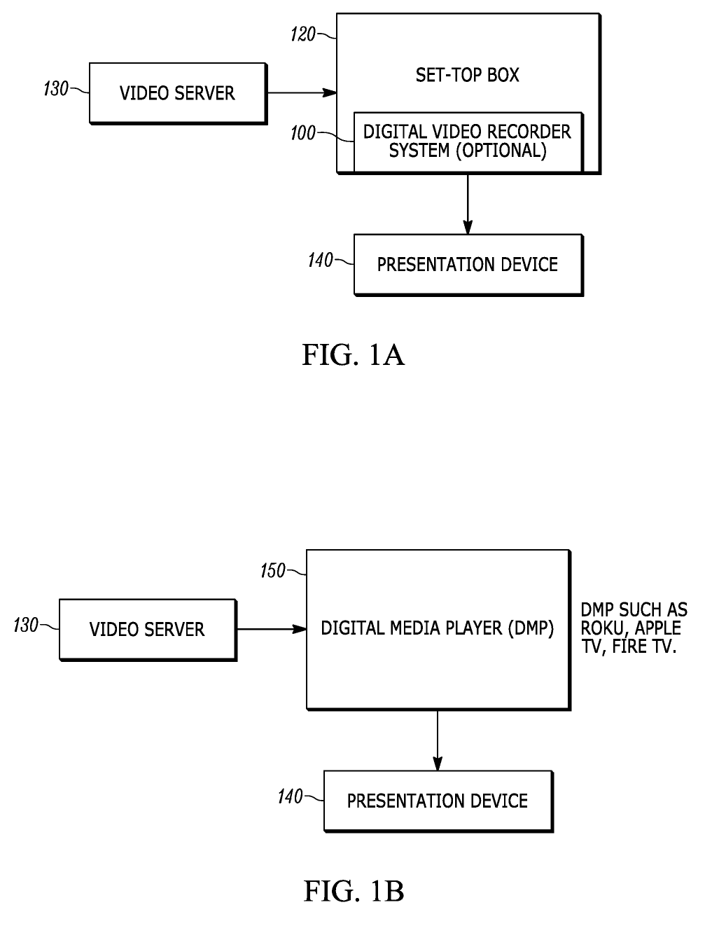

FIG. 1A is a block diagram illustrating a digital video recording (DVR) system 100 implemented in a set-top box configuration, according to an embodiment. As shown in FIG. 1A, a set-top box 120 includes the DVR system 100. The set-top box 120 is in communication with a video server 130 and a presentation device 140. The set-top box 120 is configured to receive programming signals from the video server 130, which programming signals may carry audiovisual content such as television or other types of programs. The received programming signals may carry MPEG-2 program and/or transport streams, which include elementary video streams having a number of sequentially orders video frames, or any other suitable streams.

The DVR system 100 is configured to directly record (e.g., store) received programming content, using known techniques. The DVR system 100 and set-top box 120 may then work together to play back the recorded programming content for viewing on the presentation device 140.

The video server 130 can include any device or groups of devices capable of transmitting programming content to the set-top box 120. In one embodiment, the video server 130 includes a head-end, such as a cable head-end or satellite head-end. Transmission of programming content from the video server 130 to the set-top box 120 can be performed over any communication medium(s) known to those skilled in the art.

The set-top box 120 can include any device or devices useful for receiving programming content from the video server 130 and providing the programming content to the presentation device 140 for viewing. The set-top box 120 may be configured to receive and process cable, satellite, or other types of programming signals.

As shown in FIG. 1, the set-top box 120 may include the DVR system 100. The DVR system 100 is configured to directly record (e.g., store) programming content received by the set-top box 120, using known techniques. In one embodiment, MPEG-2 transport or program streams carrying the programming content (e.g., in the form of elementary video and audio streams) are stored to a hard disk drive (not shown) or any suitable media storage device of the DVR system 100.

Along with storing programming content, the DVR system 100 is further configured to generate and store in-stream navigational data associated with the programming content. For example, a host processor (not shown) can be configured to record the navigational data. The generated navigational data may be stored to the hard disk drive (not shown) of the DVR system 100.

The navigation data can include any information useful for quickly, conveniently, and bi-directionally navigating and accessing the stored media stream data during, or in preparation for, trick mode playback. In particular, the navigation data allows specific frame types to be quickly located which enables user defined trick play frame sequences to be efficiently implemented. It should be appreciated that the media streams are not limited to MPEG-2 program streams or transport steams. Additionally, the specific frame type is not limited to I-frame only trick plays.

In some embodiments, the navigational data is generated locally by a DVR device (FIG. 1A) or it is already generated and recorded on a video server, where it can be played by a digital media player (DMP) (FIG. 1B). FIG. 1B is a block diagram illustrating a DMP system 150, according to an embodiment. The DMP 150 is in communication with a video server 130 and a presentation device 140. The DMP 150 is configured to receive and play media streams, which are pre-indexed with NCBs.

DMP 150 can include any device or groups of devices capable of playing back pre-indexed content from a server for viewing on the presentation device 140. For example, DMP 150 may include a Roku device, Apple TV device, Fire TV device, mobile device and application, etc.

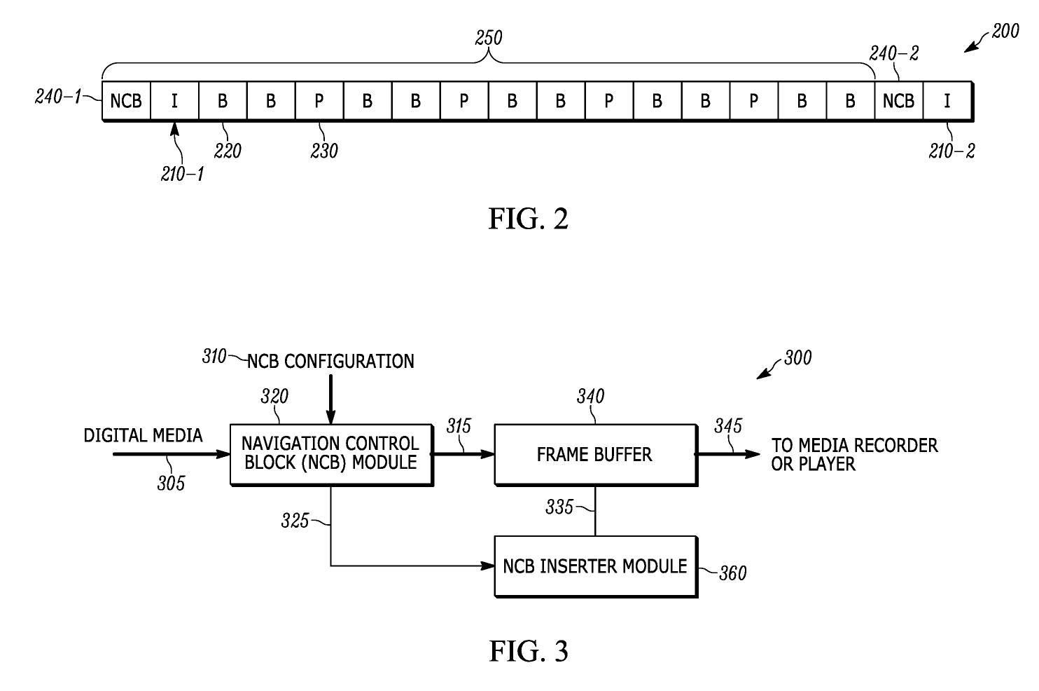

DVR system 100 is configured to generate and store navigational data associated with the programming content. In an embodiment, the generated navigational data includes indices associated with video frames of MPEG-2 elementary video streams. FIG. 2 is a block diagram illustrating video frames 210-1, 210-2, 220, and 230 of a segment 200 of a directly recorded MPEG-2 elementary video stream and associated navigation control blocks (NCBs) 240-1 and 240-2. The generation of NCBs is described more fully below in FIG. 3.

Returning now to FIG. 1A, the DVR system 100 and set-top box 120 are capable of providing stored programming content to the presentation device 140 for playback. The presentation device 140 may include a television, monitor, or other known audio and/or visual presentation devices. In particular, the DVR system 100 enables target frame trick mode playback on the presentation device 140. The programming content of target frames is processed and provided through the set-top box 120 to the presentation device 140 for viewing. Thus, viewers are able to view the content of target frames being displayed during trick play modes (e.g., fast forward, slow forward, fast rewind, slow rewind, etc.).

While FIG. 1A illustrates one particular application of the DVR system 100, it will be appreciated by those skilled in the art that the system 100 may be implemented in different applications and in a variety of different configurations. For example, in some alternative embodiments, the set-top box 120 and/or the DVR system 100 are integrated with the presentation device 140.

FIG. 3 is a block diagram illustrating an example navigation control block (NCB) generation system 300 in accordance with an embodiment. NCB system 300 includes an NCB module 320, a frame buffer 340, and an NCB inserter module 360. In some embodiments, NCB module 320 is configured to detect a target frame (Ft), insert an NCB packet at the target frame, and generate NCB data for the target frame.

Target frames (Fts) are frames for which bi-directional navigation/location is required by the system. The Ft may be identified based on digital media input and the desired trick-play and navigation requirements of the system. In some embodiments, Fts include one or more of the following frame types: I, P, B, IDR (instantaneous decoding refresh).

In some embodiments, frame buffer 340 may operate as a first-in first-out (FIFO) buffer that caches frames until each NCB has previous and next target frame references along with its own target frame reference (e.g., current target frame).

In some embodiments, NCB inserter module 360 is configured to act as a shift register/FIFO for media frames, populate the NCB data and release frames upon NCB completion. The NCB inserter module 360 may act as a shift register for frames including Fts and frames between Fts. The NCB inserter module 360 receives all frames and extracted Ft data from the NCB Module 320. NCB inserter module 360 shifts all frames into the Frame Buffer 340 and populates empty NCB data fields with the appropriate Ft data. In some embodiments, NCB inserter module 360 populates the NCBs with data from the previous target frame and next target frames proximate to the NCBs along with its own target frame reference (e.g., current target frame).

In some embodiments, frame buffer 340 releases frames upon a NCB completion. This occurs when a NCB has references/offsets to the previous target frame (Fp) and the next target frame (Fn). When a Ft is released from the frame buffer 340 all non-target frames up to the next target frame will also be released. These frames can be recorded for time-shifted playback or played immediately.

Still referring to FIG. 3, digital media in the form of a digital media stream 305 enters into NCB module 320. Also shown is NCB configuration block 310 in communication with NCB module 320. In some embodiments, NCB configuration block 310 provides instructions or rules for NCB module 320 by identifying what frame types are considered target frames and therefore will have an NCB inserted. For example NCB configuration block 310 may configure the NCB module 320 to only insert a NCB for I-frame types.

The NCB module 320 inserts an empty NCB in stream 305 at all target frames resulting in stream 315. Stream 315 is provided to frame buffer 340. In stream 325, the NCB module 320 provides extracted target frame NCB data to NCB inserter module 360. The extracted NCB data may include target frame NCB offset, target frame type, target frame size.

The NCB inserter module 360 provides the extracted NCB data to the frame buffer 340 for insertion into the empty NCB via stream 335. In some embodiments, frame buffer 340 buffers groups of three target frames at a time, including a previous frame, a next frame, and a target frame having the associated NCB. Within the frame buffer 340, the empty NCB is populated with the extracted NCB data from NCB inserter module 360. In some embodiments, frame buffer 340 also buffers all non-target frames between target frames.

In stream 345, the digital media stream having populated NCBs exits NCB system 300 and is transferred to a media recorder or player, such as shown in FIG. 1A or 1B.

Table 1 shows an example of target frame progression through frame buffer 340. As indicated above, frames are received by the NCB module 320, on target frame match an empty NCB inserted, then all frames are cached in the frame buffer 340. As subsequent target frames are received the NCB data is filled in until a single NCB references or points to a previous NCB and the next NCB. For simplicity, only target frames are shown in Table 1.

TABLE 1
Target Frame Progression

| | | | | Frame w/ |
|---|---|---|---|---|
| NCB | | | | complete |
| Module, | Frame Buffer, 340 | | | NCB |
| 320 | NextFrame | CurrentFrame | PreviousFrame | Available |
| Receives | (Fn) | (Fc) | (Fp) | from FIFO |
| Ft1 | Ft2 | Ft1 | 0 | Na |
| Ft2 | Ft3 | Ft2 | Ft1 | Ft1 |
| Ft3 | Ft4 | Ft3 | Ft2 | Ft2 |
| Ft4 | Ft5 | Ft4 | Ft3 | Ft3 |

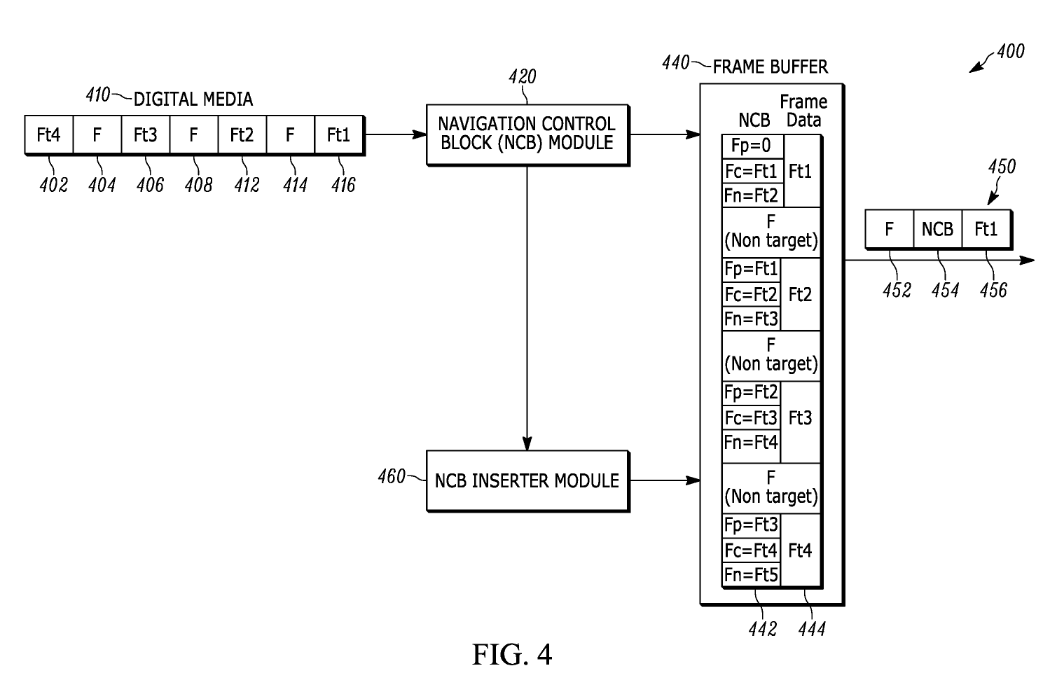

FIG. 4 is a block diagram illustrating example frame progression in accordance with an embodiment. As shown in FIG. 4, a digital media stream 410 broken into frames is pushed through an NCB generation system, as shown in FIG. 3. Media stream 410 includes target frames (Ft), which are frames that are programmed to be tagged or indexed with an NCB. In FIG. 4, there are four Fts: Ft4 402, Ft3 406, Ft2 412 and Ft1 416. Also shown are three media frames that are not target frames: F 404, F 408 and F 414.

The media stream 410 with target frames is received in NCB module 420, where an empty NCB is inserted into it for each target frame. This is best shown in the stream 450 exiting frame buffer 440, where a non target frame 452, an NCB 454 and a target frame Ft1 456 are shown. Also, NCB is located directly in-stream with the other frames.

Backing up to frame buffer 440, this illustrates NCB data 442 associated with target frame data 444. Similar to FIG. 3, NCB inserter module 460 provides the NCB data to be inserted into each NCB for each target frame. As an example, for target frame Ft1, the NCB data 442 indicates that the previous target frame (Fp) is 0 (there is no previous target frame as Ft1 is the first frame in the media stream 410), the current target frame (Fc) is Ft1, and the next target frame (Fn) is Ft2.

It should be appreciated that NCBs can be tailored to any transport protocol however, for clarity the NCB discussed hereinafter assumes MPEG-2 transport stream. In some embodiments, each NCB includes three elements: an NCB identifier, target frame information and NCB and target frame offset information. NCB identifiers may include a TransportSync/PID/Version, which allows the system to locate, identify, and parse a NCB. For example, the TransportSync allows the NCB to be inserted into any media encapsulation format/system. The PID allows the system to identify/locate an NCB in a media stream. The Version allows future extensions to the NCB.

Target frame information may include EncodingType, TargetFrameType, and/or Timestamp, which enables trick play control, provides positional information and/or enables position control. NCB and Target Frame Offsets may enable bidirectional navigation of the stream—between NCBs and/or between Target Frames.

Table 2 shows an example of an NCB and its contents. It can be seen from the NCB offset fields identified in Table 2 that a recorded media stream with in-stream NCBs can be efficiently, bi-directionally traversed enabling quick locating of all target frames.

TABLE 2
NCB Defined

| Byte | Number | | | |
|---|---|---|---|---|
| Number | of bits | Field Name | Description | Notes |
| 0 | 8 | TransportSync | Allows NCB to | 0x47 for TS. |
| | | | be seamlessly | Other transport |
| | | | integrated into | formats will |
| | | | a specific | have a unique |
| | | | transport | TransportSync |
| | | | protocol. | value. |
| 1-4 | 32 | PID | Packet | For TS it can |
| | | | Identifier. | be the actual |
| | | | Uniquely | PMT PID |
| | | | identifies | value. |
| | | | an NCB for a | |
| | | | given transport | |
| | | | protocol. | |
| 5 | 8 | Version | Version of | Supports NCB |
| | | | transport | updates/ |
| | | | specific NCB | evolution |
| 6 | 8 | EncodingType | The type of | MPEG2, MPEG4, |
| | | | media encoding | etc. |
| | | | used. | |
| 7-9 | 24 | TargetFrameType | Identifies what | Can be used to |
| | | | frame type is | determine what |
| | | | being indexed | type of trick |
| | | | by the NCB. | plays can be |
| | | | | implemented |
| | | | | and how to |
| | | | | implement them. |
| 10-11 | 16 | StartCode | Actual frame | |
| | | | start code | |
| | | | as extracted | |
| | | | from media | |
| | | | frame syntax. | |
| 12-19 | 64 | FcOffset | Current Frame | Offset of the |
| | | | Offset. | current frame |
| | | | | from the |
| | | | | FcNCBOffset, |
| | | | | effectively |
| | | | | the size of |
| | | | | the NCB. |
| 20-27 | 64 | FcNCBOffset | Current Frame | Absolute stream |
| | | | NCB Offset. | offset, from |
| | | | | zero. |
| 28-31 | 32 | FcSize | Current Frame | |
| | | | size | |
| 32-39 | 64 | FpOffset | Previous Frame | Can be Absolute |
| | | | Offset. | stream offset |
| | | | | from zero or |
| | | | | relative offset |
| | | | | from |
| | | | | FcNCBOffset. |
| 40-47 | 64 | FpNCBOffset | Previous Frame | Can be Absolute |
| | | | NCB Offset. | stream offset |
| | | | | from zero or |
| | | | | relative offset |
| | | | | from |
| | | | | FcNCBOffset. |
| 48-55 | 64 | FnOffset | Next Frame | Can be Absolute |
| | | | Offset. | stream offset |
| | | | | from zero or |
| | | | | relative offset |
| | | | | from |
| | | | | FcNCBOffset. |
| 56-63 | 64 | FnNCBOffset | Next Frame | Can be Absolute |
| | | | NCB Offset. | stream offset |
| | | | | from zero or |
| | | | | relative offset |
| | | | | from |
| | | | | FcNCBOffset. |
| 64-71 | 64 | Timestamp | Linearized | Units may be |
| | | | timestamp | application |
| | | | generated by | dependent. |
| | | | the NCB | |
| | | | Module. | |

The EncodingType field identifies the type of media encoding for the target frame being tagged/indexed by the NCB. Table 3 is a sample of possible enumerated values, however the NCB is not limited to these values.

TABLE 3
Encoding Data Type

| Enumerate | |
|---|---|
| Value | Media Encoding Type |
| 0 | Undefined |
| 1 | MPEG2 |
| 2 | AVC (H.264) |
| 3 | MPEG4 |
| 4 | WMV- Windows Media Video |
| 5 | FLASH |

The TargetFrameType field identifies what type of frame the current NCB refers to. In some embodiments, the NCB module 320, 420 is programmed with target frames, frames for which NCBs are to be generated. This set of “target frames” is application dependent and depends on the type and quality of trick plays that is desired. Table 4 is a sample of possible enumerated values, however the NCB is not limited to these values.

TABLE 4
TargetFrame Data Type

| Enumerate | | |
|---|---|---|
| Value | Frame Type | Notes |
| 0 | Undefined | |
| 1 | RA-IndependentFrame | Random access frame: |
| | | I-frame preceded by Sequence |
| | | Header |
| | | IDR-frame with SPS and PPS |
| | | This type of frame configures the |
| | | decoder and has an independently |
| | | decodable frame. |
| 2 | IndependentFrame | I-frame or IDR frame |
| 3 | P-Frame | |
| 4 | B-Frame | |
| 5 | TimingDiscontinuity | A media timebase discontinuity |
| | | has been detected, e.g. PTS. |
| 6 | ProgramDiscontinuity | A media discontinuity has been |
| | | detected: PID/Program Map Change |
| 7 | Encoding Type | EncodingType change- e.g. MP2 to |
| | Discontinuity | MP4 transition. |
| 8 | Ad Discontinuity | Could be used to denote a |
| | | commercial discontinuity or |
| | | start/end. Useful for Targeted |
| | | ad and DVR applications. |

As provided above, the NCB provides in-stream, bi-direction media stream navigation. This allows a host CPU or media decoder to provide:
Media stream positional information, offset and time.
Trick-play control such as Rewind, Fast Forward.
Relative and absolute stream positioning,
Identification of media discontinuities such as timing (PTS), program, encoding format, e.g., inserted ads.

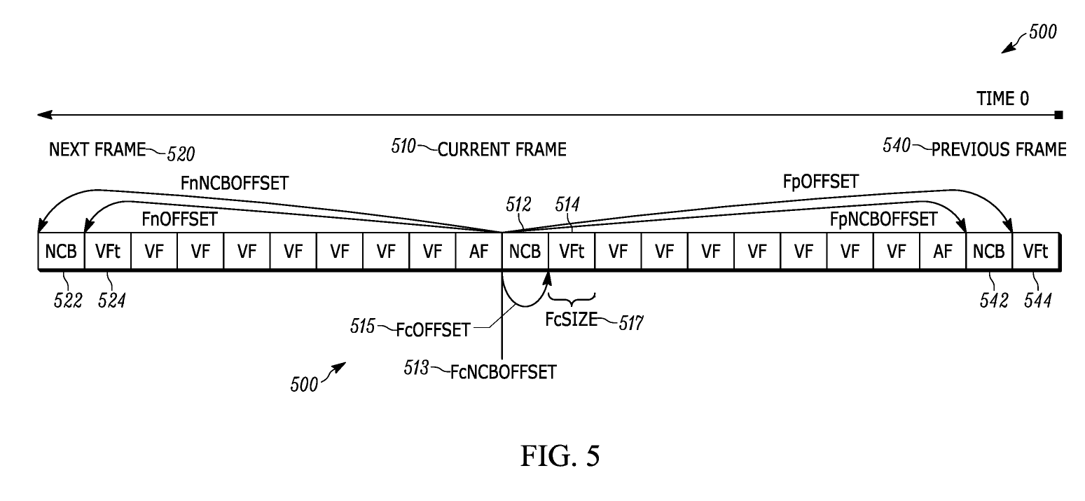

FIG. 5 is a diagram illustrating example navigation control block bidirectional navigation in accordance with an embodiment. In FIG. 5, a media stream 500 is provided showing part of a previous frame 540 (beginning at NCB 542), all of a current frame 510, which is associated with NCB 512, and part of a next frame 520 (beginning at NCB 522). Also shown are target video frames VFt: VFt 524 (associated with NCB 522), VFt 514 (associated with NCB 512), and VFt 544 (associated with NCB 542). Non target video frames VFs and non target audio frames AF are also shown.

Still referring to FIG. 5 and Table 2, offset information for the current frame 510 is shown. FcNCBOffset 513 is the current frame NCB offset, FcOffset 515 is the current frame offset, and FcSize is the current frame size. Similar offset and size information is shown for the previous frame 540 and next frame 520. In some embodiments, the current frame NCB offset, FcNCBOffset, is an absolute offset from the start of the media stream.

In some embodiments, for a given target frame the previous target frame and next target frame NCB offsets are relative to the start of the current target frame NCB. Consequently, offsets to previous frames have negative values and offsets to next frames have positive values.

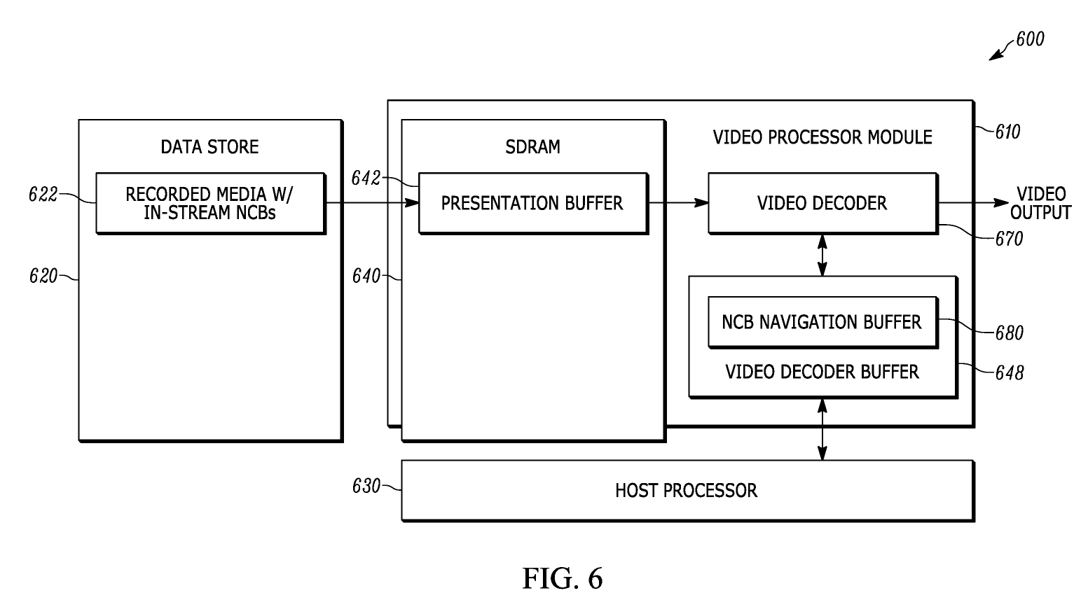

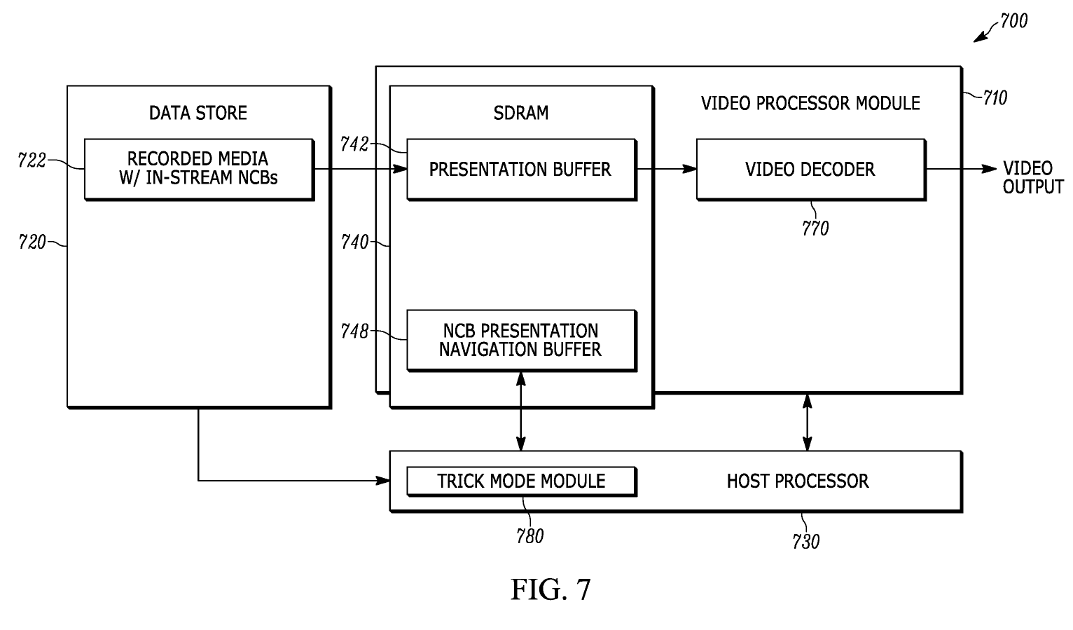

FIG. 6 is a block diagram illustrating a playback path of a DVR system 600 in accordance with an embodiment. FIG. 7 is a block diagram illustrating a playback path of a DVR system 700 in accordance with another embodiment.

As shown in FIG. 6, a video processor module 610 is in communication with a data store 620, a host processor 630, and a synchronous dynamic random access memory (SDRAM) unit 640. The video processor module 610, data store 620, host processor 630, and SDRAM unit 640 are configured to interact to access and process programming content stored in the data store 620 and generate program output data streams (e.g., video output) from the programming content for playback. In particular, program output data streams can be generated for trick play modes, including I-frame trick play modes. Audio-related output paths are not shown because trick play modes typically mute audio content during trick mode playback. The devices shown in FIG. 6 will now be described in more detail.

The data store 620 includes recorded media with in-stream NCB data 622. The recorded media stream 622 includes programming content, such as one or more MPEG-2 elementary video streams that have been directly recorded to the data store 620 and carry video programming content.

The data store 620 may include any memory device or devices known in the art that are capable of storing and accessing the media stream 622 data. In one embodiment, the data store 620 includes one or more hard-disk drives.

For trick mode playback of stored programming content, the host processor 630 accesses the media stream 622 in the data store 620 and presents the video stream data to the video decoder 670 of the video processor module 610 by way of the SDRAM 640. Any suitable known communication interface may be used to provide data communication between the data store 620 and the video processor module 610, including a peripheral component interface (PCI).

Also shown is video decoder buffer 648 in communication with video decoder 670. In FIG. 6, the NCBs are extracted and managed by video decoder 670. Video decoder buffer 648 includes NCB navigation buffer 680. In this embodiment the video decoder 670 receives the entire media stream with in-stream NCBs and parses the stream to extract the NCB data as required. The video decoder 670 can be configured for a certain position, speed or direction and can process the media stream and NCBs to achieve the requested behavior.

As shown in FIG. 6, the video processor module 610 causes the accessed media stream data 622 to be sent to a presentation buffer 642 of the SDRAM unit 640. Similarly, as the video decoder module 670 receives the media stream from the presentation buffer 642 the video decoder 670 extracts the NCBs from the media stream and saves them in NCB navigation buffer 680. The buffers 642 and 680 are configured to buffer the NCBs and the frames of the media stream data 622 according to known buffering techniques such that the data is made available to the video processor module 610 and host processor 630 at suitable times.

The video processor module 610 can include known graphics cards or other graphics-related hardware device. The video processor module 610 may include video decoder 670 configured to decode video frames of the elementary video streams of the media stream data 622. Once the frames are decoded by the video decoder 670, the frames are sent to known output generation devices (not shown) such as a display engine, which generate video output in a format that can be used by a set-top box and/or presentation device for displaying the programming content of the frames.

For normal playback mode (e.g., playback of video streams at normal speed), all of the video frames of the recorded media with in-stream NCBs are simply sent to the video decoder 670 to be decoded for use in generating video output. Video decoder 670 may ignore NCBs for normal playback. In the embodiment represented by FIG. 6, trick plays may be accomplished by host processor 630 programming video decoder 670 for a given speed and direction. The video decoder 670 then may apply proprietary frame sequencing algorithms and the target frame NCBs to achieve the desired trick play. The actual frame sequences to achieve a certain play speed is outside the scope of this disclosure.

A difference between FIG. 6 and FIG. 7 is that in FIG. 6, the NCBs are extracted and managed by the video decoder 670. In FIG. 7, the NCBs are extracted and managed by a host processor 730. Referring now to FIG. 7, a video processor module 710 is in communication with a data store 720, a host processor 730, and a synchronous dynamic random access memory (SDRAM) unit 740. The data store 720 includes recorded media with in-stream NCB data 722. The video processor module 710 may include video decoder 770. SDRAM unit 740 includes a presentation buffer 742 and a NCB presentation navigation buffer. In the embodiment depicted in FIG. 7 the host processor 730 and trick mode module 780 may simultaneous receive the recorded media 722 for NCB extraction and buffering.

Host processor 730 may program the trick mode module 780 for a given speed and direction. The trick mode module 780 then may apply proprietary frame sequencing algorithms and the extracted target frame NCBs to achieve the desired trick play by sending only those frames from the presentation buffer 742 to video decoder 770. The actual frame sequences to achieve a certain play speed is outside the scope of this disclosure.

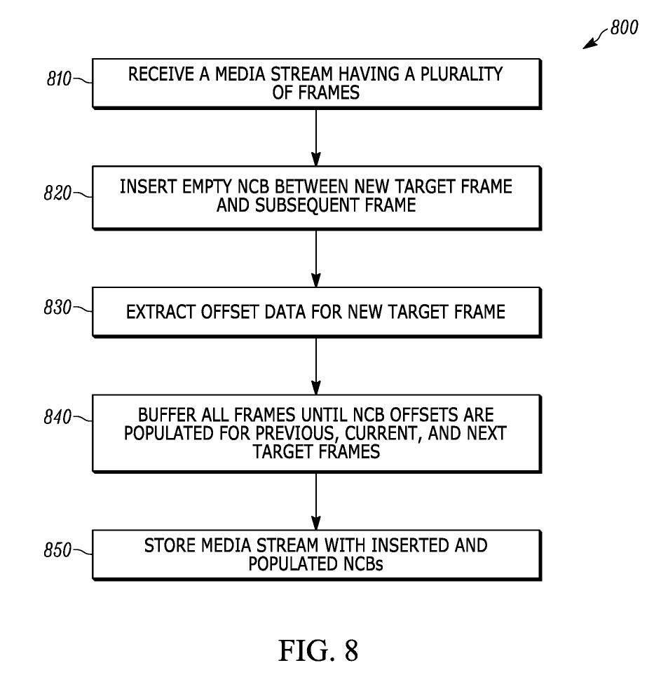

FIG. 8 is a flowchart illustrating a method 800 for creating navigation control blocks in accordance with an embodiment. Method 800 begins in block 810, where a media stream having a plurality of frames is received. The frames may include one or more target frames and non-target frames, such as shown in FIG. 5.

At block 820, an empty NCB is inserted proximate to a current target frame. At block 830, offset data for the current target frame is collected from the current target frame. After three target frames are processed by block 820 and block 830 offset data is available for a current, previous, and next frame allowing a complete NCB.

At block 840, a group of frames are buffered until the NCB offsets are populated into the empty NCB associated with the current target frame. The group of frames may include the previous target frame, current target frame, next target frame, and any non-target frames located in between.

At block 850, the media stream with the inserted and populated NCBs is stored. This stored media stream may be played back in DVR systems shown in FIG. 6 and FIG. 7.

There are a number of benefits associated with the NCB architecture disclosed herein including:
The NCB architecture produces a single file with the NCB data integrated with the original media stream.
The single file NCB can be parsed and processed in a way similar to a separate index file architecture.
Decoder hardware can be customized to process the single NCB file enabling the host CPU to just send the entire file as-is to the decoder.
   For normal speed play decoder hardware can discard NCBs.
   For trick plays decoder firmware can be programmed for direction, speed, and mode (e.g., I-frame only) and then extract NCBs to control decoder behavior as frames are received.
Not limited to media recorders—can be applied to media players to enable navigation and trick plays on any content including over the top (OTT) content.
   OTT content can be processed by the NCB Module and then could support real trick play modes such as Rewind and Fast Forward.
Supports any encoding format.
NCB blocks can be produced for any media type, AN, video only, audio only.
Supports and identifies transitions between encoding formats; e.g., MPEG2 to MPEG4 and vice-versa.
Identifies media timing discontinuities such as PTS discontinuity.
Identifies program discontinuities such as inserted ads or PMT/PID changes.
Reduces HDD wear and tear by reducing frequent head seeks between index (meta-data) file and media file. This applies to recording and playback.
Reduces HDD audible noise by reducing frequent head seeks between index (meta-data) file and media file. This applies to recording and playback.
Increases HDD throughput for n-tuner DVR applications by eliminating all separate index file accesses. This applies to recording and playback.
Each NCB provides bi-directional, in-stream media navigation data.
   Helps identify previous target frame and next target frame.

Accordingly, the present disclosure is not limited to only those implementations described above. Those of skill in the art will appreciate that the various illustrative modules and method steps described in connection with the above described figures and the implementations disclosed herein can often be implemented as electronic hardware, software, firmware or combinations of the foregoing. To clearly illustrate this interchangeability of hardware and software, various illustrative modules and method steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the disclosure. In addition, the grouping of functions within a module or step is for ease of description. Specific functions can be moved from one module or step to another without departing from the disclosure.

The various illustrative modules and method steps described in connection with the implementations disclosed herein can be implemented or performed with a general purpose processor, a digital signal processor (“DSP”), an application specific integrated circuit (“ASIC”), a field programmable gate array (“FPGA”) or other programmable logic device, discrete gate or transistor logic, discrete hardware components, or any combination thereof designed to perform the functions described herein. A general-purpose processor can be a microprocessor, but in the alternative, the processor can be any processor, controller, or microcontroller. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the implementations disclosed herein can be embodied directly in hardware, in a software module executed by a processor, or in a combination of the two. A software module can reside in computer or machine readable storage media such as RAM memory, flash memory, ROM memory, EPROM memory, EEPROM memory, registers, hard disk, a removable disk, a CD-ROM, or any other form of storage medium including a network storage medium. An example storage medium can be coupled to the processor such that the processor can read information from, and write information to, the storage medium. In the alternative, the storage medium can be integral to the processor. The processor and the storage medium can also reside in an ASIC.

We claim:

1. A method of indexing a media stream comprising:
receiving a media stream having a plurality of frames including a current target frame, a previous target frame and a next target frame;
inserting an empty navigation control block (NCB) proximate to the current target frame to which it is associated; and
populating the NCB with data including offset data for the previous target frame, current target frame and next target frame.

2. The method of claim 1, further comprising:
identifying a target frame type to index.

3. The method of claim 1, wherein the NCB is inserted into the original media stream.

4. The method of claim 1, further comprising:
populating the NCB with data including NCB offset, frame type start code data, target frame offset.

5. The method of claim 1, wherein the previous target frame and next target frame are buffered while the NCB associated with the current target frame is populated.

6. The method of claim 1, wherein the NCB is configured to reference the previous target frame and the next target frame.

7. The method of claim 1, further comprising:
populating the NCB with data including timestamp data for the current target frame.

8. The method of claim 7, wherein the timestamp data provides positional information for indexing the frames in the media stream.

9. The method of claim 1, further comprising:
populating the NCB with data including encoding type data for the target frame and target frame type data for the media stream.

10. The method of claim 9, wherein the encoding type data identifies the type of media encoding for the current target frame.

11. The method of claim 10, wherein the type of media encoding is selected from the group consisting of: MPEG-2, AVC, MPEG-4, WMV, FLASH, and unidentified.

12. The method of claim 9, wherein the target frame type data identifies the type of frame being indexed by the NCB.

13. The method of claim 12, wherein the type of frame is selected from the group consisting of: RA-IndependentFrame, IndependentFrame, P-Frame, B-Frame, TimingDiscontinuity, ProgramDiscontinuity, encoding type discontinuity and ad discontinuity.

14. A system for navigating a media stream having a previous target frame, a current target frame, and a next target frame, the system comprising:
a data store for storing a media stream and navigation data for navigating said media stream, said navigation data provided in one or more navigation control blocks (NCBs) inserted proximate to a target frame in the media stream; and
a processor module in communication with said data store and configured to access said media stream, said processor module including a decoder configured to decode said current target frame in the media stream and extract the navigation data from the NCB.

15. The system of claim 14, further comprising:
a navigation control block module in communication with the processor module, said navigation control block module configured to insert one or more empty NCBs into the media stream.

16. The system of claim 15, wherein the navigation control block module is further configured to populate the one or more empty NCBs with offset data for the previous target frame and next target frame.

17. The system of claim 16, wherein the offset data for the previous target frame and next target frame is extracted from the previous target frame and next target frame.

18. The system of claim 14, further comprising:
a frame buffer in communication with the processor module, said frame buffer configured to cache the previous target frame and next target frame while an NCB for the current target frame is being populated with navigation data.

19. The system of claim 18, wherein the navigation data comprises at least one of: timestamp data for the target frame, encoding type data for the target frame, and target frame type.

20. The system of claim 14, wherein said navigational data includes a plurality of in-stream NCBs, and wherein said decoder is configured to navigate in a bi-directional manner through the media stream using the NCBs.
